(19) United States
(12) Patent Application Publication
(10) Pub. No.: US 2015/0365359 A1
(43) Pub. Date: Dec. 17, 2015

(54) HTML5-BASED MESSAGE PROTOCOL

(71) Applicant: Russell Hasan, Norwalk, CT (US)

(72) Inventor: Russell Hasan, Norwalk, CT (US)

(21) Appl. No.: 14/733,858

(22) Filed: Jun. 8, 2015

Related U.S. Application Data
(60) Provisional application No. 62/011,779, filed on Jun. 13, 2014.

(51) Int. Cl. H04L 12/58; G06F 17/24; H04L 29/08; G06F 17/22

(52) U.S. Cl. CPC H04L 51/04; G06F 17/2247; G06F 17/248; H04L 67/02

(57) ABSTRACT

One embodiment of a web-based message protocol using HTML video and audio tags to dynamically serve the video and audio parts of an asynchronous multimedia message having message parts selected from the group consisting of video, audio, images, text, and links, by interpolating video and audio file names into the video and audio tags based on identifying data connecting a message part to a message. Other embodiments are described and shown.

### CROSS-REFERENCE TO RELATED APPLICATIONS

This application claims the benefit of provisional patent application Ser. No. 62/011,779, filed 2014 Jun. 13 by the present inventor.

### BACKGROUND

### Prior Art

Web-based message systems commonly use either an email protocol or an SMS protocol, although some new systems use a unified communications protocol, which is based on a telephony protocol. For example, Google Gmail and Microsoft Outlook both use an email protocol, and, for example, Twitter, at least in its original 140 character “tweet” form, essentially used a modified SMS-like protocol.

Email as a communications protocol suffers from several disadvantages. Despite being commonly served to email clients from an email server, each email may contain all of the data associated with that email. Thus, if an email has a video attachment that is 25 megabytes large, if that email is sent to 40 different email addresses on different email systems, the total data storage for that email then is 1 gigabyte, despite the basic email itself only being 25 megabytes, because the data is replicated 40 times. Emails are often replied to with reply emails, and then replies to the replies are sent back and forth, and so on, such that email data storage can become quite cumbersome. Also, when a video is attached to an email as an email attachment, the video must then be downloaded from the email, the video must be saved locally which is charged against the user's local data storage costs and capacity, and a video client capable of playing that file format must be found, and the video must then be played, which involves several steps. The same is true in most instances for an audio file, and in some instances for an image. Even when a user uploads a video or image to an email, it can be confusing to know whether an email has video or audio and, if so, what process should be used to download and view it, as email clients do not generally come with clear instructions or methods for doing this.

SMS is useful only for text, and does not integrate into multimedia messages well. A different protocol for multimedia called MMS was developed but was complicated and did not catch on. For smartphones, messaging apps exist, but the disadvantage of an app, much the same as with any standalone program run off an operating system, is that it requires the operating system, and as such is not guaranteed to be operable across all computers and all devices, unless a separate and compatible client has been coded for each operating system. Thus, SMS and apps for widespread communication where cross-compatibility is necessary pose real challenges.

Unified communications is a family of technology that has evolved to attempt to integrate video and audio into a message system with email, text and links more efficiently. However, the way that this is actually done, most frequently, is by simply grafting a telephony protocol for audio onto a system that deploys an email protocol for text. Thus, all of the disadvantages of the email protocol are retained, and the disadvantages of the telephony protocol, such as difficulty with asynchronous communication and a lack of good support for video, are added into the pool of potential problems.

### SUMMARY

In accordance with one embodiment a web-based message comprised of message parts selected from the group consisting of video, audio, text, images, and links, inputted and outputted through HTML5 tags, and with the video and audio served using interpolation into video tags and audio tags.

### Advantages

Accordingly several advantages of one or more aspects are as follows: to provide messages with message parts of types limited to types of content that can be inputted and outputted easily through HTML5, to provide messages that have maximum compatibility across all operating systems with web browsers that support HTML5, that use video files and audio files with a minimum needless reduplication of data from messages that are sent to multiple people or in replies and counter-replies, that use an input and output interface of pages divided into sections which is easy to use for people to include links, images, audio and video easily side by side with text by designating specific areas on the pages for each message parts type so that users readily understand where to go to and what to do to use video or audio or other message parts. Other advantages of one or more aspects will be apparent from a consideration of the drawings and ensuing description.

### DRAWINGS

### Figures

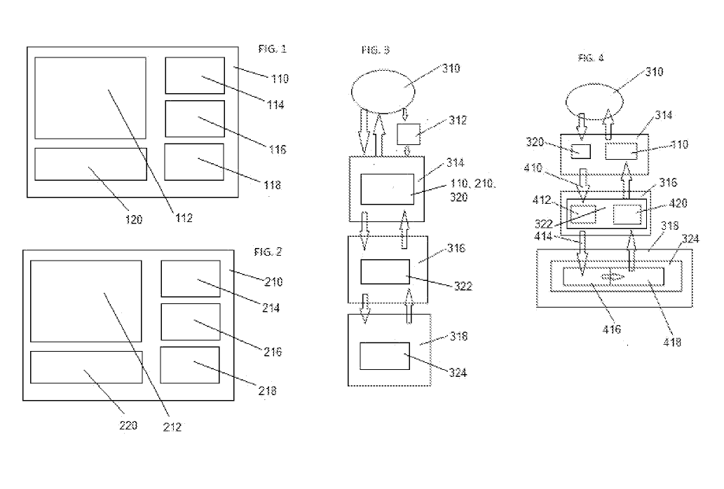

FIG. 1 shows a message comprised of text, an image, a video file, an audio file, and links, outputted through a web page with a different section for each message parts type, constructed in accordance with one embodiment.

FIG. 2 shows a message input page with a form with different sections for inputting each different type of message part, constructed in accordance with one embodiment.

FIG. 3 shows the hardware including the computer executing a web browser, the webcam device, the computer executing a web server, and the data storage device connected to the web server, showing their interconnection to form a messaging system, constructed in accordance with one embodiment.

FIG. 4 shows the process whereby a user enters a command in the web browser to view a message and this command is processed by the server-side script to then access a message database using a message-identifying data to find the message parts, and the server-side script then assembles the message parts into the HTML message output, and outputs the message parts to the web browser, showing the flow of data in a messaging system, constructed in accordance with one embodiment.

FIG. 5 shows the process whereby identifying data identifies a video or audio file associated with a data object, and input related to the data object is used to identify the associated video or audio file which is then served to the user in a context relating to the data object, constructed in accordance with one embodiment.

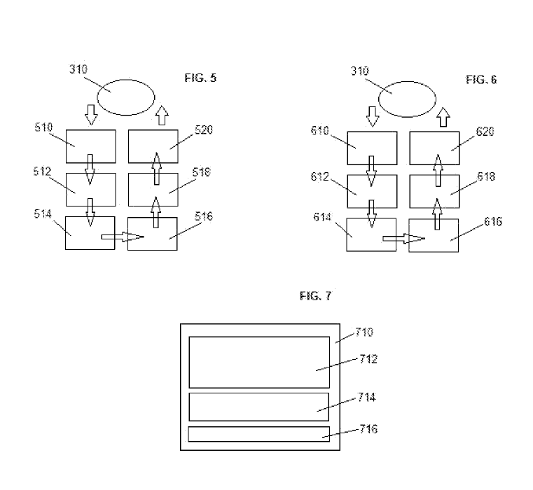

FIG. 6 shows the process whereby a user inputs data containing message-identifying data, the video and audio file associated with the message is identified using the message-identifying data, the video and audio file name and directory are interpolated into the HTML5 video or audio tags, and the video and audio files are served to the user as message output, constructed in accordance with one embodiment.

FIG. 7 shows an output page where messages and a message input form are connected to a web page or software output which contains content that is not messages, constructed in accordance with other embodiments.

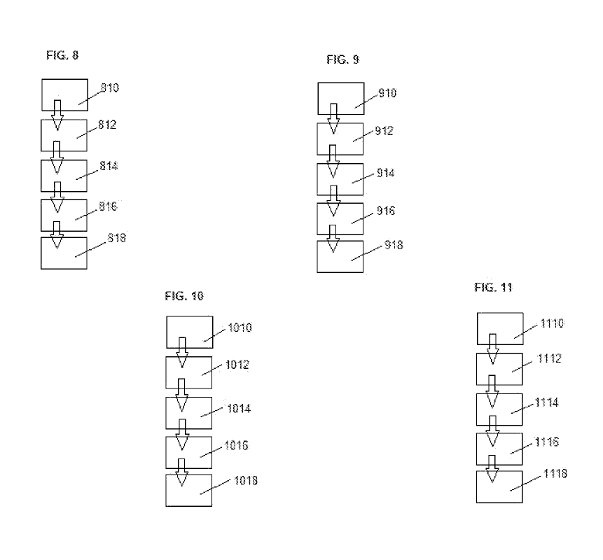

FIG. 8 shows the process whereby a first user creates a message and uploads it to the server, a message identifier is sent to a second user's inbox, and a second user opens the message from the inbox and views the message, constructed in accordance with one embodiment.

FIG. 9 shows the process whereby a first user creates a message and uploads it to the server, an email containing a link is emailed to a second user, a second user clicks the link, and the message opens in the web browser, optionally with password protected access, constructed in accordance with other embodiments.

FIG. 10 shows a process whereby a first user creates a message and uploads it to the server and selects a keyword hashtag, a second user selects a keyword hashtag for his inbox, a message identifier is sent to the second user's inbox, and a second user opens the message from the inbox and views the message, constructed in accordance with one embodiment.

FIG. 11 shows a process whereby a first user creates a message and uploads it to the server, the first user reviews the message, and the first user edits or cancels the message.

### REFERENCE NUMERALS

110 message output web page
112 text in page section for text
114 video in video tag in page section for video
116 audio in audio tag in page section for audio
118 image in image tag in page section for image
120 links in anchor tags in page section for links
210 message input web page
212 text input form element in page section for text
214 video input form element in page section for video
216 audio input form element in page section for audio
218 image input form element in page section for images
220 links inputs form elements in page section for links
310 user
312 webcam
314 computer executing web browser software
316 computer executing web server software
318 data storage or computer-readable memory
320 inbox page
322 server-side script
324 database and file folders containing message parts
410 request for message sent from web browser to server-side script accompanied by message-identifying data
412 message-identifying data
414 database query for message parts sent from server-side script to database and file folders containing message parts
416 message database record identified by message-identifying data
418. message parts identified by message-identifying data in message database record and/or file folders, comprising text, links, video, audio, and/or image
420 HTML code defining message output web page created by server-side script interpolating message parts into message template, further including, if video files or audio files are message parts, by interpolating video file names into video tag code snippets and interpolating audio file names into audio tag code snippets
510 user enters input related to data object with identifying data
512 software processes input and collects identifying data
514 identifying data identifies video file or audio file associated with data object
516 file names and directory paths of associated video file or audio file are collected from a process based on identifying data
518 file name and directory path is interpolated into video tag or audio tag
520 HTML code containing video tag or audio tag is outputted to web browser which serves video file or audio file to user
610 user enters input containing message-identifying data
612 server-side script processes input, collects message identifier, and sends query to database using message identifier to identify message in database record
614 message identifier is used to select database record containing message
616 database sends data on file name and directory path associated with message to server-side script
618 file name and directory path is interpolated into video tag or audio tag in HTML prepared by server-side script
620 HTML code containing video tag or audio tag is outputted to web browser which serves video file or audio file to user
710 computer output display screen
712 content that is not messages
714 message output space
716 message input space
810 first user inputs message and selects second user as recipient
812 software stores message in database
814 software sends message identifier to second user's inbox
816 second user selects message identifier in inbox
818 software outputs message web page HTML to second user's web browser
910 first user inputs message and selects second user's email as recipient
912 software stores message in database
914 software emails dynamically generated URL link to second user's email
916 second user opens email and clicks on dynamically generated URL link
918 dynamically generated URL link opens message in second user's web browser, optionally through a password-protection dialogue requiring a password to access the message
1010 first user inputs message and inputs a keyword hashtag as recipient
1012 second user selects the keyword hashtag for his inbox
1014 software sends message identifier to second user's inbox
1016 second user selects message identifier in inbox
1018 software outputs message web page HTML to second user's web browser
1110 first user inputs message
1112 software stores message in database
1114 first user reviews message
1116 first user edits or cancels message, optionally uploading new message parts to message while editing
1118 software alters or deletes message based on editing or cancellation

### DETAILED DESCRIPTION

### First Embodiment

In one embodiment, a message is comprised of message parts selected from the group consisting of text, images, links, video files, and audio files. A message output web page (FIG. 1) exists and a message input web page (FIG. 2) exists. The message output web page 110 contains sections each for outputted text 112, video 114, audio 116, images 118, and links 120. The message input web page 210 contains sections each for inputting text 212, video 214, audio 216, images 218, and links 220.

In one embodiment, the hardware is what is referred to in computer science as the three tier architecture, comprised of the user-facing front end, the data processing back end, and the data storage behind the back end, which is illustrated in FIG. 3. In one embodiment the front end is a web browser interpreting HTML, the back end is a server-side script coded in PHP (although other embodiments coded in, for example, Java EE or ASP.Net can easily be imagined), and the data storage is a database coded in SQL (although other embodiments coded in NOSQL are within the realm of consideration). A diagram of the hardware (FIG. 3) shows this arrangement, with a user 310 who records a video using a webcam 312. The user faces a computer executing web browser software 314, which displays a message input web page 210. The message input web page 210 is connected via the internet to a computer executing a web server 316 which runs a server-side script 322. The computer running a web server 316 is connected to a data storage or computer readable memory 318 which contains a database and file folders 324. For specific examples of hardware, a Dell laptop running Windows OS or an Apple iPhone running iOS could be the computer running a web browser, and a dedicated server built by Cisco running an Intel CPU could be the computer running a web server, and this Cisco server could also run an Oracle SQL database. These examples are, of course, not intended to be limiting.

In one embodiment, the inbox 320 connects to the system in such a way that it sends a message identifier 412 in a request for message 410 through the web browser into the internet where it is received by the server-side script 322. The server-side script 322 then connects to the database via a query 414. The query 414 reads a database record 416 that connects to message parts 418 which are returned to the server-side script 322. The server-side script 322 then connects the message parts 418 into a message HTML code 420. This series of interconnections is illustrated in FIG. 4.

One embodiment uses interpolation to serve video files and audio files related to a data object, as illustrated in a series of steps in a process shown in FIGS. 5 and 6. In the first step, the user enters input related to a data object 510. Video files and audio files associated with the data object are identified 514, file names of the files are collected 516, and then file names for the identified files are interpolated into video and audio tags 518, and HTML code containing the tags with interpolated names is outputted 520. This process is shown for data objects in FIG. 5 and more specifically for messages in FIG. 6.

One embodiment connects a first user to a second user through a process using an inbox (FIG. 8), in which a first user inputs a message 810, the message is sent to a second user's inbox 814, and the second user selects the message in the inbox to open it 816. Another embodiment is a variation on the inbox using hashtags (FIG. 10) wherein a first user sends a message to a hashtag 1010 and a second user selects a hashtag for his inbox 1012 and the message is sent to the inbox 1014. In another embodiment the step of options to edit or cancel a message 1116 is inserted into the process (FIG. 11).

### Operation

This invention utilizes developments in computer technology, namely HTML5<video> and <audio> tags, to create a system which can be used for creating messages comprised of message parts selected from the group consisting of text, links, images, video, and audio, and organizing these messages into a messaging system with an inbox. Alternate embodiments discussed below disclose a system that an internet media, such as an online magazine, could use to let users post video and audio messages to the comments section of the page with an article on it, and a messaging system where the messages can be sent to people who do not have user accounts and access to the messages from outside the system can be protected and managed.

In at least one or more embodiments, a data object is associated with at least one or more videos or audio files, and HTML5 is used to serve the media associated with that data object in a context relating to the data object after user input selects data that identifies the data object. Data object should be defined broadly to include any collection of data or representation in data or a thing or object that is represented by data. Thus, a thing exists, it is embodied in data, and this becomes a data object. A user selects an indication of the data object within its software context, and the software then serves associated video or audio using HTML5 to create a cross-platform operating system-independent media distribution.

In several more specific embodiments, the data object is a message. Message should also be defined broadly, to include any asynchronous communication between two or more human beings for any purpose analogous to a purpose of human language, e.g. to communicate, speak, transmit information, send data, etc. More detailed embodiments will become easily understood from the examples offered in this disclosure.

HTML5<video> and <audio> tags enable the programmer to embed video and audio files into a website. The tags take the file's name and directory as its source attribute. When the HTML renders in a web browser which supports HTML5, the video and audio tags trigger a media player native to the web browser, and the video or audio file plays in the website. The surprise is that HTML5, which was designed for better websites, can be used for new advantages in web application software in sophisticated designs far beyond just posting a video to your website, which is HTML5's original use. Specifically, the use of HTML5 video for videos in messages in messaging web applications is one embodiment of the present invention.

Because almost every computer and device runs an operating system that supports at least one or more web browsers, and most current web browsers support HTML5, the only thing the user needs to have for a web application is a web browser, which most people already have. Because all the complicated data processing work is done on the server in a web application design, the use of HTML5 web applications enables complex computational tasks that are easy for the end user and permit wide cross-platform inter-compatibility.

Recently there has been growth in the widespread popularity of webcams and microphones in laptops, smartphones, tablets, and mobile devices. Such connected devices can used to record a recording using video and audio recording software native to the device and the device's native webcam or phone camera and microphone. The device's web browser or mobile web browser can then be used to connect to a server, and the recording can be uploaded to the host server through the internet.

In order to build the embodiment, it is useful to possess some background knowledge about computer programming and web development, which a person having ordinary skill in the art would already know. These include the following: a web browser is a computer program run on a computer or mobile device. A web server is a program run on a computer that sends hypertext markup language (HTML) code to the web browser, and the browser then interprets the HTML to generate a web page that a user sees in his web browser. Note that a server is actually software and literally any computer could be configured to become a server, although some people only refer to dedicated servers as servers, a dedicated server being a specialized computer with hardware optimized for use as a server. It also worth noting that the term computer is used in this disclosure in its broadest sense, to indicate any machine with a CPU executing instructions from a computer-readable medium, and as such the term includes mobile devices, tablets, and smartphones, which, after all, are simply a type of computer.

A uniform resource locator (URL) is the address of a web page, for example, http://www.samplepage.com/homepage is a URL for that sample web page, and typing this URL into a web browser would direct the user to that sample web page.

A web server can run a server-side script, which is a program that processes data and then dynamically generates HTML to send to the user's web browser. The HTML code runs on the client side, in other words, it lives in the web browser in the user's computer, whereas the server-side script lives in the server, and the user cannot directly access it or see it, he sees only the HTML code that comes from it through the internet into his web browser. Dynamic generation means that the generation is done anew with different variations each time the server-side script is run. HTML forms can be used for a user to upload files and input text and data to a server from his web browser through the internet.

To continue the background for the embodiment, a web server can contain files that hold data, but a web server can also be connected to a database, which is a computer program that stores, manages, and retrieves data. Dedicated server hardware often connects a web server to a database, so that data for either a website or a web application can be stored in the database and sent to the web server. A database often stores data in a collection of database tables. A database table is a table that holds data.

A database table for web applications is typically written using SQL. An SQL database table is a table of columns and rows, where the columns are referred to as fields and the rows are referred to as records. Each record generally refers to one object or unit or one collection of data, and each different item of data in the object or unit or collection for that record is stored in a different field in that same record. There is typically a field in each table called an index, and the index is used to find and identify specific records. The index is often a number which identifies a record, for example record 357 has the number 357 in its index field. The index is typically an integer, and it is typically auto-incremented, meaning that the next index is the most recent index plus one. The index is also often referred to as the record ID. Thus, if the most recent record is record ID 47, then when a new record is created it will automatically be assigned ID 48. SQL fields in a record can have different data types, such as integers or text. One table in an SQL database can be “joined” to another table in this way: A field in one table contains the ID of a record in another table, which “joins” the second table to the first table. Joining is an easy way for a script to go from the record in the first table to refer to and access the corresponding joined records in the other table.

Typically a web server can be attached to a database running SQL, in which case the web server can send data to and read data from a database table in an attached database. In this case, the server-side script can process data from the database and use this data processing to make decisions in the program logic that generates the HTML code for the web pages sent to the web browser.

Client-side programming, which refers to a program that runs in a web browser, can be written in the computer language called JavaScript. A server-side script can be written in the computer language called PHP, although many other languages, such as Java and ASP.NET, are also used. JavaScript and PHP can both interact with the computer language called HTML, that is, hypertext markup language, which is the core of what defines actual web pages. A database can be written in the computer language called SQL.

A web page of HTML code is made of tags which contain attributes, and the attributes define the content of the tag as it displays in the web page. For example, the source attribute of a tag is a computer file that the tag refers to or pulls data from. So an HTML image tag that says <img src=“Dog.jpg”> would create an image on the web page viewed by the user where the image content is pulled from the Dog.jpg file on the web server. Popular tags include the image tag for images, the anchor tag for links, which is what typically appears when there is a link in a web page that you click to go to a different page, and the paragraph tag and the div tag, which are used to hold elements, including text strings. Text is typically outputted as a text string, the most basic way that text can be handled on a computer, although HTML often wraps text strings within paragraph tags. Text has a variety of tags that can be used to style the text, but the pure text itself can be included in HTML directly in the body of the web page as a text “string,” where string is the computer programming term for any series of characters, such as letters, which are connected together in a sequential series. HTML5 has added a new way to output text, namely the canvas tag, which outputs text as a string but styles its appearance and formatting using JavaScript. Text in HTML can be outputted in many ways: for example, as a text string wrapped within a paragraph tag or div tag, which is the most basic type of text (optionally styled using CSS code, for example, changing font size or font color), as a text string within a heading tag (which makes the text bigger and bolder), or as text within a canvas tag that uses JavaScript to be styled (for example, changing font colors or casting a shadow).

A server can serve web pages written in HTML using templates or code snippets. A template is a structure of HTML tags that forms the skeleton of the page, and a server-side script can add details and flesh to the template when it generates the code to send to the web browser. A code snippet is a small chunk of HTML code, basically a small template, and code can be dynamically added into a code snippet. A code snippet can be written to accomplish a specific task, and one snippet can be included in multiple different pages to add the same functionality to all pages that include it. Alternatively, a server-side script can dynamically generated different snippets and add them to one template, in which case each different snippet changes some small section of the web page viewed by the user.

Two tags new to HTML5 are the video tag, which is coded as <video>, and the audio tag, which is coded as <audio>. These tags were designed to add videos and audio files to websites. Background for the embodiment which specifically impacts video and audio tags is the use of codecs. A codec, which means a coder/decoder, is a program or method that takes raw video footage or audio sound and translates it into a data stream, which is coding, and this coded data can be sent to a recipient through the internet, and the decoder of the recipient enables the recipient to decode the data and translate it back into the video images or audio sounds to be seen or heard by a human.

Although the computer programming commands for <video> and <audio> tags in HTML5 are fairly uniform, there is some variation in the codecs supported by the web browser's native media player. The Google Chrome web browser uses an unpatented free open source codec called WebM, which is managed and promoted by Google. In contrast, the Microsoft Internet Explorer web browser uses a patented proprietary codec called MP4/H.264, and Microsoft, along with Apple and other co-owners collectively known as MPEG LA, charges a license fee to use H.264. A different free open source codec called Ogg is also supported in some browsers. Recently all modern web browsers, including Google Chrome, have shifted to support for MP4, which is widely available through a license from MPEG-LA.

Thus, the use of video and audio tags will be influenced by which browser is used and whether the user is willing to pay a licensing fee for wider coverage. However, aside from the licensing fee and the specific codec used by a browser, the basic skeleton of video and audio tags works the same across most browsers that implement the video and audio tags. Note that HTML5 is drafted as specifications by the organization called W3C, but the computer programming companies that make web browsers, such as Google for Chrome and Microsoft for Internet Explorer, do often included unique variations and twists in their implementations of the HTML5 specification, so the video and audio tags, like all tags, will have some browser-specific quirks, despite a general structure that is uniform across most implementations.

Having established a basic level of knowledge, the operation of an embodiment should be fairly easy to understand. In one embodiment, message web pages created by users are sent back and forth between users as a form of communication which can be referred to as a seesaw chat, although the precise term of art is asynchronous communication. Synchronous communication is when both parties to the conversation are talking to each other live in real time, such as in a real time chat room or over the phone. In contrast, in asynchronous communication, such as is used in one embodiment, each party takes a turn, and the conversation goes back and forth, and a communication can be received at a time substantially later than when it was sent.

The seesaw chat conversation proceeds in a seesaw-like action in which one side records a message and posts it to the server and the other side then accesses the server, plays the recording, records a reply, and posts the reply message, which the first side then views and records another message to reply, and so on. Each time a user uploads and publishes a message may be referred to as that user's turn in the seesaw chat. Seesaw chat has been called by other names such as video texting when done through smartphone apps and asynchronous video conferencing when done through video conference hardware terminals, but the terms asynchronous communication, or seesaw chat, best capture the steps in the process.

One embodiment of this invention delivers messages by a means such that, when a sender uploads a text message and a video and/or audio message for a recipient, and where both sender and recipient have accounts on the same messaging system, the messaging system dynamically creates a web page with the text message as HTML text on the page, and with the video and/or audio recording displayed using HTML5 tags with source attributes of those video or audio files stored on the server, and the recipient views and accesses the message by viewing the dynamically generated web page. Thus, a new web page with dynamic HTML5 tags and/or with a unique URL is dynamically generated for each message. Each turn in the seesaw chat generates a new web page.

Audio and video recordings in the messages are accessed by the user by means of a website serving HTML5<video> and <audio> tags (or their equivalent in yet-to-be-developed and later versions of HTML or other web page languages) served repeatedly to the user, with a server-side script interpolating the names of each individual clip to the HTML5 tags source file attribute, with the tags served dynamically to the user via HTML5 code generated by a server-side script such as written using PHP or another scripting language. In other words, when a message is created, a unique web page is created which displays the video and audio parts of the message (with whatever text, image, links, or other parts the message has), and the message is viewed by accessing and viewing that unique web page.

Interpolation refers to the ability of PHP and other server-side programming languages to interpolate variables into HTML code prior to serving the HTML to the client web browser. A variable is present in a code template or code snippet, and interpolation is the act of plugging a value into the variable, which value then substitutes in place of the variable when the source code executes. A PHP script is a server-side script which processes data and then creates HTML code which it sends to the client-side web browser. The web browser then renders the HTML, which creates a web page for the user to experience. PHP can process data and modify the HTML code that it serves, such as by interpolating variables into HTML code. When a variable is interpolated into HTML code the PHP takes a PHP variable that was in an HTML template and plugs different values into the variable in the space which the variable occupies in the HTML template. Thus, an HTML page can be one template but contain a value that changes dynamically because the value changes when the variable's value changes. This embodiment uses this technique to make the source attribute of <video> and <audio> tags change dynamically via interpolation. The source attribute of a video or audio tag is the name and directory of the video or audio file played in the web browser.

For example, a normal HTML5 video tag might say:

<video src=“fileNameOfFileOnServer.mp4”>
This would serve that video file through the web browser's native media player. An amateur duck hunter might store a home movie of his recent duck hunt on his server and display it on his website about duck hunting using that HTML. This works because there is only one video and that video's name and location on the server do not change. In an embodiment, the PHP server script processes the input from the user to identify the message that the user seeks to view, and then interpolation is used.

In one embodiment the HTML5 and PHP code says:

<video src=“<?php print ($dynamicVideoVariable); ?>”>,

and in another embodiment the PHP code says:

<?php print <<<HERE
<video src=”$dynamicVideoVariable”>
HERE; ?>

In each embodiment the variable $dynamicVideoVariable is changed by the PHP program to match the file name and location of that specific message's corresponding video file. Then when the HTML5 code snippet created by the PHP script is served to the web browser it will contain a dynamic source attribute to the video. For example, in both of the embodiment examples mentioned above, the PHP would result in HTML on the client's web browser saying, for example,

<video src=“fileNameOfFileOnServer.mp4”>

In one embodiment the value of the video file (i.e. the name and directory path of the file) that goes with a message can be stored externally in an SQL database, and the PHP script can read data from the user's request for a message, identify the ID of that message in the SQL database, and can then read the video file data from the SQL database, process the data, put the correct file name into the variable, and then interpolate the variable into a prewritten video tag and then serve it to the user's web browser.

For an example of this, if a message contains a video that is stored on the server under the name and directory C://Messages/VideoMessagefromJohntoJoe.mp4, then when Joe selects the button or link to view the message sent to him by John, the variable $dynamicVideoVariable will be assigned a value of VideoMessagefromJohntoJoe.mp4 (with the directory path as necessary appended to the front of variable value), so the web browser page will then play that video part of the message from John to Joe.

In one embodiment each message will consist of a video and/or audio tag (possibly with other content and message parts) on a new web page dynamically generated by a server-side PHP script. In one embodiment, data to use to output the message is passed to the server in the URL through the GET method of data transfer. In another embodiment the system does not generate an entire new web page for each message. Instead, a master web page is created, and a new unique snipped of HTML to serve the video and/or audio tag is created each time a link to a message is clicked by a user to view the message. In this embodiment the user clicking a button or link to view a message triggers an AJAX (Asynchronous JavaScript and XML) request to the server, which will run a PHP file on the server to serve the message to the AJAX call, the PHP program will then dynamically generate HTML5 code with the video and/or audio tag serving the video and/or audio file that forms that message, and this HTML5 snippet will be sent back to the AJAX call from the PHP, and the HTML snippet will then be rendered in a partial section or area of the master web page where such area or section is the area or section for the currently selected message to display.

In one embodiment the messages are parts of web pages, and the entire web page does not need to reload in order for a new message to load. In other words, AJAX can be used so that a new message loads without the whole web site reloading, and it can be used to create and edit messages and/or message parts without the whole site reloading when the message is sent. In one embodiment there is a PHP full reload of the page for a new message and in another embodiment an AJAX snippet load into a preexisting page for a new message will be used.

In one embodiment, a message in the system is comprised of multiple message parts, with one message added by one user via one message input web page divided into different sections one section for each part type. The message consists of at least one or more these parts, such that there can be any number of each type of part in one message, and such parts are tied together if a message contains more than one part: a text string, an image, an audio file uploaded to the server, a video file uploaded to the server, and links to web pages or files or documents accessible through a web browser and the internet. In another embodiment one message has only one text part, only one image, only one video, only one audio file, and up to five links, in each one message.

The different parts of the message can be tied together in a number of different ways in various embodiments. In one embodiment, a message identifier, in other words, a message-identifying data, is used to identify all the various message parts belonging to one message. In one embodiment, the message identifier is an integer which is the index of the main database table that stores message data. In one embodiment, the message database table fields are, first, the index, which is the message identifier, and can also be called the message ID, then, in a predetermined order, a field that stores the message text, a predetermined number of fields which each contain a link index that identifies a link in a table of links joined to the message table by an inner join, a field that contains a flag as to whether the message contains an image, a field that contains a flag as to whether the message contains a video file, and a field that contains a flag as to whether the message contains an audio file. The flags in one embodiment are set to yes or no, or their equivalents, and in another embodiment are set to true or false.

In this embodiment, the creation of a new message operates thusly: a user accesses a create new message web page, with different sections for inputting text, inputting links, and uploading an image, a video file, and an audio file. In one embodiment, the new message web page contains an HTML form, and the text input is a form element of type text input or text area, the links are form elements of type link, and the image, video and audio file inputs are form elements of type file. The user enters text, enters links, and selects image, video, and/or audio files from his local computer to upload. The user then selects a command to upload the data and create the message. The user also selects at least one or more recipients for the message, either by selecting from a list of eligible recipients, or by typing identifiers of recipients into a field for recipient data to be entered. In an embodiment, the recipient identifier is a username.

When the user selects to upload the new message, a new database record is created in the message database table, with an index created by automatically incrementing the prior most recent index, for example if the previous message was message ID 375 then this message is ID 376. The text is then written to the text field. If there are links, the system checks to see if those links already exist in the links table, and if so, it collects the link IDs and writes the link IDs to the links fields in the message record. If those links do not already exist in the system, then new records in the links table are created, each new link is given a new link ID, and the new link IDs are written to the links fields in the message record. If the message contains a video then the server-side script saves the video to a file folder on the server or in a data storage connected to the server. The video file saved to the server is given a name that contains the message ID plus an identifier that it is a video. For example, the video for message ID 376 could be saved as V376.mp4. The same process for a video is applied to an image or audio file uploaded with the new message except that the identifier will identify an image or audio file instead of a video. For example, an image could be saved as I376.jpg and an audio file could be saved as A376.mp3. In each case, if an image, video or audio file is uploaded, then the flag for that message having an image, video, or audio file is set to “yes.” Note that the system in one embodiment will validate the data by checking to make sure that the uploaded file is in a file format supported by the system, specifically, that images, videos, and audio files are in formats supported by HTML5. The files will be saved with file extensions identifying the file format, such as, for example, saving a video with .mp4. In another embodiment, the software has one preferred file type, e.g. MP4 for video, and will only validate files in its preferred file formats.

The output of a message in this embodiment operates like so: the messaging system is given a command to output a message, and the message ID of the message is passed to the system. This calls a server-side script which opens a template of a message output web page. The server-side script then queries the message table with that message ID and pulls the record for that ID. This collects the message text, which is interpolated into a variable in text section of the message output web page template. In one embodiment, the text in the template is within a paragraph tag. In one embodiment, the system allows the user to use CSS3 to style the text, and in another embodiment the text is within the HTML5 canvas tag and uses JavaScript to be styled. The script collects the link IDs for the message from the message record, then queries the links table for the links matching those link IDs, and interpolates the links into values in anchor tags in the template. The script then collects the flags for images, video, and audio. If, for example, the video flag says yes, then the script includes a video tag snippet in the template, which snippet says: (Note that in PHP the dollar sign indicates a variable):

$directory = “/filefolderpath/”;
$Video = $directory . “V” . $messageID . “.mp4”;
<video src = “$Video” >

Thus, a video file name is formatted according to the message ID with the video identifier, file format, and directory path concatenated to it according to the rules of the logic of the video file naming scheme. The net result of this is that the video file name outputted is identical to the file name of the video that was uploaded with the message. So message ID 376 would have an outputted video tag saying: <video src=“/filesonmyserver/V376.mp4”> which could pull the corresponding video off the server and send it to the output web page. The user can then play the video in the native video player in his web browser on any HTML5-compliant web browser.

The same process is used to input and output images and audio files, except that the file format and file type identifiers differ. For example, for images I and .jpg or .png replace V and .mp4, and for audio files A and .mp3 are used instead of V and .mp4.

In this embodiment, the message ID is the only message-identifying data that the software logic needs in order to manage the creation and retrieval of messages.

Note however that this disclosure is not intended to limit the invention to this embodiment, and several other data design embodiments are plausible. The message ID could be some sort of text taken from aspects of the message, such as a message title, a date when the message is created, the first sentence of message text, etc. Also, instead of storing text in the message record, the message text could be stored in a different text table joined to the message table by a text ID in the message table joined to a text ID in the text table. The records in the message table could be the actual directory path and file name of the video files, audio files, and images, instead of flags, or they could contain pointers to file names in a file names table, for example a file names table could contain the name of video ID 7 and the message database field for video would then contain the integer 7 to identify video file name ID 7 in the videos table. And it is perfectly possible for one message to have more than one video file as part of one message, for example, an additional identifier such as 1, 2, 3, etc. could be concatenated to each video file name to distinguish it, or different video IDs could be stored in one message record. Similarly, one message may contain multiple text parts, one or more links, and multiple images or audio files, as well as multiple videos. And a message need only contain one message part and does not necessarily need any others. For example, a message could be just a video, or just a text, or just a link, etc.

For an example of an embodiment, a field for message ID 23 might contain a message ID field containing the value 23, a text field containing the message “John, I won't be able to make it to the meeting today, very sick, play attached video for recap of negotiations, James,” and a video field containing the file name and directory path of a video on the server recorded by James wherein James tells John about the negotiation taking place that involves their business.

In one embodiment the input and output for each message part type are in the same place on the message input web page and the output message web page. In one embodiment, the text is in a text box in the lower middle, the title is in the upper middle, the video and/or audio is in the upper right, the links are in the lower right. In at least one or more embodiments the positions of the sections for parts types are uniform across both the output message web pages which display the message, and also on the form elements of the message input web page which contains the HTML form that a user submits to create a message and to add to a preexisting message. Thus, a user who uses the system frequently will easily know where on the page to look to find a specific message part by type.

A more detailed description of the overall operation follows:

The user accesses a message creation page 210 and enters text, uploads the video and/or audio and/or images, and enters links Upon a command to upload the message, the message parts are sent to a computer executing web server software 316, where a server-side script 322 processes the uploaded data and stores it in a database and file folders 324 in a data storage or computer readable memory 318. In one embodiment, the user who sends the message selects at least one or more recipients for the message.

In an embodiment, a message also includes a title and metadata. In one embodiment, there is a field on the message creation page to input a title, which is stored in the title field of the message SQL table. In one embodiment, a database inbox table also exists which has a user ID and the message IDs of every message sent to that user. In one embodiment when a user selects to open his inbox web page, the system queries the inbox table, which collects the titles and message IDs for every message in this user's inbox, as well as various metadata. In one embodiment, the metadata includes the date and time the message was sent, and in one embodiment it includes whether the message is unread or has been read before. The system then outputs an inbox page 320, which comprises a list of message titles formatted as HTML links or HTML form buttons which will pass the message ID to the system when the link or button is clicked. In one embodiment metadata is used to sort the messages within the inbox, such as, for example, by most recent data and time, or by unread above and read below, although other possibilities will easily occur to the software engineer The user can select a message identifier 412 by clicking the message's title, which, upon selection, causes the web browser to send a request for a message 410 to the server-side script 322 accompanied by the message identifier 412.

In one embodiment, a user's request for a message leads to an outputted message by a process wherein the server-side script 322 receives the request for a message 410 from the user's selection of a message in the inbox 320 and pulls the message parts from the database and file folders 324 by sending a database query 414 using the message identifier, wherein said message identifier is a message ID that identifies a message database record 416, and that database record 416 contains the message parts 418. In an embodiment, the database record 416 contains the message ID as an index, and the record then also contains the message text, as well as links identifiers that identify links text in a joined database table, as well as flags to indicate whether the message does or does not also contain an image, a video file, and an audio file. In this embodiment, the server-side script 322 takes the message text and links returned by the database query, inserts them into a web page template, and, if the video, audio or image flags said yes that the message has those parts, then an image file name, video file name, or audio file name based on the message ID is interpolated into image, video, and audio tags in the web page template. The server-side script 322 then formats the web page template with the message parts interpolated into it into HTML code 420 which it sends to the computer executing a web browser 314, and the web browser then outputs a message output page 110 to the user recipient.

In one embodiment, each user is assigned a user ID, which the system uses to keep track of senders and recipients, with the user IDs in fields in the inbox table. In another embodiment, a message can be sent to a hashtag, which is a text keyword. In this embodiment, each hashtag is given a hashtag ID, and each message sent to a hashtag contains that hashtag ID in at least one or more fields in the message record. A user may then select a hashtag for his inbox. The inbox query will then take the hashtag IDs associated with this inbox and query the message table for all messages containing that hashtag ID. The messages sent to the hashtags of the inbox will then be included in the messages displayed in the inbox, alongside the messages sent to the user. So the software logic works the same as a normal inbox, except that, instead of message sent from sender to recipient, the message is sent from sender to hashtag and from hashtag to recipient. As may be readily apparent, the hashtag embodiment enables a social network or social media for sharing messages to be easily integrating into a message system comprised of private messages between individual users.

In a seesaw chat, because the message is uploaded to a server before the recipient views it, one embodiment gives the user an option that the sender can play back a preview of the message, including the video and audio segments of the message, to evaluate whether or not he likes it and can then leave alone to be read in its current form or else delete it by canceling the message, or edit it by removing a message part from the message and replacing it with a new message part, for example replacing one video with another, or by changing a message part, for example editing text. In one embodiment this is done by giving the sender a mock-up page of the message page that would be accessed by the recipient as it would be viewed by the recipient, so that the sender can play the audio and/or video in his browser and see it as the recipient will see it. A sender can edit or cancel a message after it has been uploaded and sent to its recipients, using an aspect of the software design that is identical to editing or cancellation after a preview of the uploaded message before is sent to recipient, although this feature is most useful if the editing or cancellation is made before the recipient views the message. This embodiment, in summary, enables messages to be cancelled or edited after they are uploaded, which is different from an email system, because in this embodiment all messages are stored in a server that the sender can access after the message is uploaded, whereas when an email is sent the email travels from the sender's email server to the recipient's email server, and the sender typically lacks access to the recipient's email server. In an embodiment, technologically, cancellation works simply by removing the message ID from the inbox record of the recipient user, and editing works by simply updating the SQL field for the message part that is edited, or by deleting an old file from the server and saving a new replacement file into its place, as for example when editing a video.

The following verbal flowchart discloses how to code one or more embodiments: Code a PHP script that outputs an HTML form containing a text input for title, a text input for message body, five URL inputs, one file input labelled video, one file input labelled audio, and one file input labelled image. Give the user a field to enter the username of at least one or more recipients. At the end of the form include a submit button that calls a server page. Send the variables using the POST method. Code that server page to collect all variables from the PHP POST variables. Having already created an SQL database, write to a database messages table a record with an automatically incremented index, write the title to a title field, and write the text to a text field, and get the message's ID using PHP's last insert ID function. Optionally, enter the date and time the message was created into a date-time field in the SQL, for example using the SQL now function. Check to see if any URL links were entered. If any were, check to see if the link already exists in the links table. If it does, pull its ID and write the link ID to link fields in the message record. If it does not, create a new links record for each link, pull that link ID using a last insert ID function, and write the link ID to links fields in the message record. Check to see if video, audio, or images were uploaded. If they were, check the file name to make sure the extension indicates a supported file type. If not, do not process the files. If yes, save the files to a folder in the server, using this naming scheme: for video, “V”. messageID. “mp4.” (assuming that MP4 is the file type in use). Do the same for audio files but with “A” and .mp3, and with images as “I” and .png. If a video, audio, or image file was successfully saved, write a “yes” as a flag in the video, audio, and/or images field in the messages table. If there was no video, write “no” in the video flag, and do the same for audio and image. Lastly, collect the recipient's username, and look up his user ID in the users table. Then write a record to the inbox table containing that recipient's user ID in the recipient field and the message ID in the message field.

Code an inbox page in PHP. First code a sign in page where the user signs in, reads the username and pulls the user ID from the users table, and which stores the signed in user's user ID as a session variable. Begin the inbox page by reading the username from the session. Then query the inbox SQL table to find every message with that user's user ID in the recipient field and pull each of those messages' message IDs. Optionally, sort them by date and only pull the twenty most recent messages. Then output HTML wherein for each message an anchor tag is coded wherein said anchor tag is a link to a message output page and passes that message's ID to the output page using GET data transfer. Then read the title field from the messages table for each record matching those message IDs. Then enter the message title from the messages table as the text within each anchor tag. Then output that list of twenty anchor tags as the inbox page.

Thusly, it should be readily apparent that clicking a message title will then open a message output page with that message ID passed to the message output script. Code the message output script as follows: First check to make sure that the signed in user is a recipient of the message, but reading the user ID from the session, reading the SQL inbox table to see that a record exists where the user ID is that user ID and the message ID is this message's ID. If no, do not serve the message. If yes, read all fields from the record in table messages matching that message ID. The message output script contains a message template with variables. The script can interpolate the title into a title variable within a heading tag at the top of the page. It can interpolate the message body into a variable within a paragraph tag in the middle of the page. Read the video, audio, and image flags. If video is “yes” interpolate the message ID into the video tag code snipped, which can say <video src=“V”. $messageID. “.mp4”> or something similar. Do the same for audio with an audio tag and for the image with an img tag. This will automatically output the video, audio, and image which were saved with the name including that message ID. Put the video tag in the upper right corner, put the audio tag below it, and put the image below it. If the flag is no then don't output the video, and so for audio, and image; use an if statement to only execute the video code if the flag was yes. Read the link IDs from the message, read the links table for the links having those IDs, and wrap those links within anchor tags and include them in the lower left corner. If there are no links then leave that space empty. Then output the message's HTML from the web server to the user's web browser.

For keyword hashtags, in one embodiment the software logic works similarly, except that a hashtag substitutes for a recipient's username in the program logic. That is, in one embodiment, a message is sent to a hashtag, an inbox subscribes to a hashtag, and where a user subscribes to a hashtag then an entry is made in the inbox table with that message ID and that user ID when a message is sent to the hashtag. In one embodiment, subscribing to a hashtag writes the user's user ID to a hashtag table in a record containing that hashtag, and when a message is sent to a hashtag, a server-side script pulls a list of all users subscribes to that hashtag from the hashtag table, and writes records in the inbox table placing that message into the inbox of every subscribing user. In an embodiment, review of a message works like outputting a message, except that it is outputted to the sender instead of the recipient. Editing a message, in an embodiment, alters the message database and rewrites old files with new files with the same file name, using SQL. Cancelling a message, in one embodiment, deletes the entry in the inbox table which places that message into the recipient's inbox, and may also include deleting the SQL records and/or associated files for that message.

From this description the user will understand that the message ID is the message identifier that united the message parts into one message so that interpolation and HTML5 served a multimedia message using a web-based messages and inboxes system.

### Description and Operation of Second Embodiment

In a second embodiment, the messaging system can be modified and implemented as a comments board for articles or topics of discussion in an internet media, such as an online magazine. In this embodiment, the system is implemented for a specific page or set of pages, e.g. where each page has one article on it, and the comments board will be for commenting on or discussing that article. In an embodiment a web page or software output has content that is not messages, with a message input form and/or messages included below or next to the content. In an embodiment a page will have a segment appended to the bottom of the page for inputting comments. Each comment will be structurally similar to a message as described in the previous embodiments. Each comment will consist of a section containing the parts of messages described above.

In this embodiment the content web server and the comments web server can be the same server or different servers. If they are the same server then the content is stored on the same server as the messages. If the messages system is on a different server than the content, then when the user opens the web site containing the content then the content web server passes the URL of the content web page to the messages server and the messages server identifies the messages posted to that URL and sends the messages either back to the content web server or directly into the web page on the client's web browser. In an embodiment a database table exists with a URL ID and message IDs to associate messages to a URL used to identify a web page of content or a software output of content.

In at least one or more embodiments, video and audio can be uploaded as message parts for a comment. The system where all people may upload video or audio would require the media's server host to accept uploaded audio and video files from the public, and could use either third party antivirus software or manual human review of uploaded files or a system to validate user trustworthiness to avoid viruses or Trojans uploaded as video or audio files.

The messages as comments are not mapped to the items of the media, e.g. the articles or content on the page, and a comment is related to its article only by being uploaded and viewed on the same page and URL as the article, with the software system matching comments to their web pages. In other words, the internal software logic of the system is content-agnostic and cares only about the web pages and does not know what content or media is on the pages when it decides which comments to append to a page.

In a related embodiment, this system is used by a video or audio content creator, such as a band or filmmaker, as a system to distribute media and simultaneously foster discussion of the media. The system works as described above, but the administrator selects a group of people who are given contributing user status, and the administrator selects a different group of people to be eligible to be given accounts to receive and comment upon the contributions. In one embodiment the contributing user is a band or filmmaker and in another embodiment the contributing user is a company or organization which creates or distributes audio or video content. In one embodiment the group of users who receive content and comment upon content are the public, in another embodiment they are paying subscribers, and in another embodiment they are a list of fans of the contributors taken from external sources.

This embodiment works by the unrelated pages containing songs, films, or other video and audio (and/or text) media, embedded in the messages as HTML5<video> and <audio> tags (and/or as plain text), which people can then discuss using messages as comments on the system. It is a feature of this system that users can share content by sharing links to the pages on the server which contain the content, i.e. by linking to static unrelated content pages. Thus, a user could post a comment on a video and include a link to said video in the comment. Also, the IT system administrator can track message views to track the popularity of a media content.

The program logic for one embodiment works as follows. In one embodiment, the messaging system functions as described for the first embodiment, but in its use as a comments board for unrelated pages, the message ID goes into a comment database table wherein one field in each record is the text string comprising the name of the URL of the content page and one or more later fields in that record are the message ID numbers of the messages that are comments which belong in the comments board for that content page. The web developer or web site manager who creates the content page or a server-side script which dynamically generates the content page (which also called the unrelated page) must include a comments board code snippet in the HTML of the content page. The comments board code snippet is used to trigger a comments board call to query the comments database table to seek and find the records whose URL field matches that URL, and then find all message IDs in that record, and then pull and display all matching messages with those message IDs in the comments board on the content page, up to the predetermined limit of number of messages displayed per content page.

Thus, the point of connection between the messages and the unrelated page or content page is the URL in the comments database table which contains records where each record contains one field with the URL text string and other fields with the messages or message IDs. The comments board code snippet is also used to serve an HTML snippet of an input form for posting a comment to the content page, which is functionally similar to creating a message using a message input form in other embodiments.

### Description and Operation of Third Embodiment

In a third embodiment, the system functions as described in the first embodiment but with the addition that people who do not have user accounts in the system can access message pages sent to them by a process wherein the messaging system sends an email to the person's third party email account and the email contains a link in the email which directs the person's web browser to a message page served by the message system web server, with that message page containing the message for the person. Optionally, the system may password-protect the message page, and optionally the password for the message may be included in the email or by a different means for secure password transmittal.

The problem with video and audio embedded in emails is that it is troublesome to create them, there is a virus threat to play them because Trojan viruses can be embedded in audio and video files, and they should be streamed from the same server that the viewer is accessing, or else the server will be in danger of being hacked from streaming video or audio from another server. If HTML5 tags are embedded in emails, there is also a problem of matching the tag's source attribute to the file name and file directory structure of the video or audio file, because the tag's code is locked once it is sent so any changes to the file name or directory on the source server would cause the tag to point to a file that no longer exists at that location.

An embodiment solves these problems. In this embodiment a message is created as described above, a message page is created, and the message is then sent to other users who are not on the same server and/or do not have accounts on the internal messaging system by emailing the recipient an email to their email address wherein the body of the email contains a link to the message page on the sender's server. The recipient would then click the link to be taken to the message page, where he can view the message and play the audio and video parts of the message by rendering the HTML5 tags in his browser and using his browser's native HTML5 video and audio player.

In one embodiment, access to the message is controlled so that only the intended recipient can view his message by dynamically generating the message page URL and matching it to the URL of the link in the sent email. In another embodiment, access is controlled by password-protecting the message page with a password included in the email or given to the recipient by the sender separately, e.g. by the sender telling the password to the recipient over a secure voice phone call. This enables the sender to control the message and protect access to the message despite a URL that in theory any web browser could send an HTTP request to, and the audio and video is played from the server that is accessed by the viewer, i.e. the sender's server serves the message page and the audio and video. Also, the URL of the message page can change dynamically but still use a static location on the sender's server for the audio and video file for the tag source attribute because the server-side script will interpolate the file name and directory into the dynamically generated message page, which solves the problem of audio and video file locations moving around for audio/video emails. Thus, this system is an improvement over pure audio/video emails or HTML5 tags embedded in emails.

The program logic of one embodiment works as follows. A user creates a message and designates an email address as the recipient. The user also enters a password for the message. The system stores the password and the message ID in a database passwords table. The system sends an email to the recipient's email address. The email contains a link that includes the URL of the message web server and the link passes the message ID to the web server. The web server then sends a web page that prompts the recipient for a password. The recipient enters the password. The server-side script checks to see if this password matches the message's password. If it does, then the server-side script sends the HTML for the message to the recipient's web browser. The web page received by the recipient's web browser may be referred to as a public message web page, in the sense that anyone who entered that URL into a web browser would request that page from the server. This is why password protection may be desirable for an embodiment.

An example link is

http://www.mymultimediamessagingsystemurl.com/fromemail.php/?messageid=235

Which, when clicked, will prompt the user to enter the password for message ID 235, and, upon correct password entry, will send the message web page to that user's web browser.

In one embodiment the sender chooses the password, and in another embodiment the password is generated by a random password generator on the system and this password is then given to the sender to be shared with the recipient. In an embodiment the password is in the email body of the link email. In another embodiment the password is given to the recipient through a different means for secure password transmittal, such as over the phone.

### CONCLUSION, RAMIFICATIONS, AND SCOPE

Accordingly, the reader will see that the messages of the various embodiments can be used to achieve multimedia messages easily inputted and outputted across computers and devices running most any operating system. Various embodiments make use of the messages in the context of unrelated software systems, and make it possible to send messages to users outside the message system. Messages make a maximally efficient usage of video and audio data storage for multimedia messages, and easily integrate into a variety of uses, including messages for business, messages for personal use, and messages for social media use.

Although the description above contains many specificities, these should not be construed as limiting the scope of the embodiments but as merely providing illustrations of some of several embodiments. Any computer running a web browser connected to any computer executing a web server could be used for a web-based embodiment, and any logical equivalents of a web browser and web server can be used. For example, software could be configured to run an app on a smartphone or tablet wherein the app would function identically with a web browser for the purpose of inputting and outputting messages by interpreting HTML or HTML-like code, and a cloud server can function identically with a web server. Also note, in this context, that any computer can be configured to act as a web server, so the same web-based messaging system could be run off a dedicated server, or could be run off one or a plurality of local computers running web server software, in a hybrid peer to peer model.

And, lastly, note that a video file typically contains a video portion and an audio file wrapped together in a video wrapper, thus, the use of a system which did not explicitly include audio files and instead combined video, links, images, and text, would in actuality still necessarily serve audio files as part of their video files, albeit through the video tag instead of the audio tag, but the use of video tags and audio tags is logically equivalent, both being HTML5 multimedia tags, and so it would be equivalent to an embodiment. It would also be an equivalent design to store the video files and audio files as binary code blobs of data within the SQL database, instead of storing them in file folders on the server, and then dynamically serving the video and audio binary data through video tags and audio tags through the web application, which process would simply consist of interpolation from the file stored in the SQL instead of interpolation from the file stored in a directory path folder.

Thus the scope of the embodiments should be determined by the appended claims and their legal equivalents, rather than by the examples given.

What is claimed is:

1. A system or method of integrating video and audio into web-based software, comprising:
a. providing a hypertext markup language video tag or audio tag in a web page template,
b. providing a video file or audio file,
c. providing a data object,
d. providing a video file name or audio file name,
e. providing identifying data that associates said video file or audio file with said data object,
f. providing a computer executing a computer program that takes input related to said data object, processes said input with said identifying data to identify which video file or audio file is associated with said data object, and dynamically interpolates said video file name or audio file name into said hypertext markup language video tag or audio tag in said web page template to serve the video file or audio file associated with said data object.

2. The method of claim 1 wherein said data object is a message.

3. A system or method of creating a message on a computer, comprising providing a computer executing a computer program that inputs and outputs a message comprised of at least one or more message parts wherein each message part is selected from the group consisting of:
a. text,
b. an image,
c. an audio file,
d. a video file, and
e. a link,
and wherein:
a. said text, said image, said audio file, said video file, and said link are inputted through at least one or more hypertext markup language forms,
b. said text is outputted as a text string in hypertext markup language through a paragraph tag, div tag, heading tag, or canvas tag,
c. said image is outputted through a hypertext markup language image tag,
d. said audio file is outputted through a hypertext markup language audio tag,
e. said video file is outputted through a hypertext markup language video tag, and
f. said link is outputted through a hypertext markup language anchor tag.

4. The method of claim 3 further including a message input page divided into sections wherein one section is for text, one section is for images, one section is for audio files, one section is for video files, and one section is for links, and a message output page divided into sections wherein one section is for text, one section is for images, one section is for audio files, one section is for video files, and one section is for links.

5. The method of claim 4 further including:
a. providing a source attribute in said video tag or said audio tag,
b. providing a code snippet of hypertext markup language in a message web page template containing said video tag or said audio tag,
c. providing a variable placed in the location of the value of said source attribute of the tag in the code snippet,
d. providing a video file or audio file,
e. providing a file name and directory path of said video file or said audio file,
f. said computer program performing interpolation of said file name and directory path of said video file or said audio file into said variable in the source attribute of said video tag or audio tag in the code snippet.

6. The method of claim 5 further including:
a. providing identifying data that associates a message part to a message by a means for joining a first data item to a second data item in a database, and
b. wherein said message part is a video file or audio file, said computer program processing said identifying data to identify a file name and directory path for said interpolation by a process of (1) receiving inputted data that corresponds to said identifying data, (2) identifying the message corresponding to the identifying data, (3) identifying the file name and directory path associated with the message, and (4) interpolating the identified file name and directory path into the code snippet.

7. The method of claim 4 further including that at least one or more elements selected from a group consisting of:
a. an output space for at least one or more messages, and
b. an input space to input a message
is outputted in a section of a content web page and wherein a message of a content web page is connected to a content web page by a means for associating a content web page's URL to a message.

8. The method of claim 6 further including a title of said message and a plurality of metadata of said message, and further including providing a messaging system comprised of a first user, said first user having a first user's message input page, and a second user, said second user having an inbox and a second user's message output page, wherein said first user sends a sent message to said second user through the process of:
a. inputting a sent message into said first user's message input page,
b. said messaging system sending the sent message to the second user's inbox,
c. said second user's inbox displaying as a message's title and wherein the title is sorted using the metadata and further including an association between said title and said identifying data,
d. said second user inputting a selection of the sent message in the inbox,
e. said selection sending said identifying data to said messaging system, and
f. said sent message outputting in said second user's output message page.

9. The method of claim 8 further including a message sent by a person within said messaging system to a person outside said messaging system having a third party email address wherein said messaging system sends an email to the third party email address wherein said email contains a link to a public message web page.

10. The method of claim 9 further including password protection for said public message web page and further including a password to unlock said password protection which is given to a recipient by a means for securely transferring a password from a sender to a recipient.

11. The method of claim 8 further including a hashtag keyword, a message sent to said hashtag keyword by said first user, a selection of said hashtag keyword for said inbox by said second user, and a stream in said inbox comprised of a plurality of messages sent to said second user and messages sent to said hashtag.

12. The method of claim 8 further including options selectable by said first user to review, edit, or cancel a message after it has been uploaded.

13. A machine for creating a message, comprising a computer configured to input and output a message comprised of at least one or more message parts wherein each message part is selected from the group of different types of message parts consisting of:
a. text,
b. an image,
c. an audio file,
d. a video file, and
e. a link.

14. The machine of claim 13 wherein said message input page is a web page served through a web browser, and said message output page is a web page served through a web browser, and wherein:
a. said text, said image, said audio file, said video file, and said link are inputted through at least one or more hypertext markup language forms,
b. said text is outputted as a text string in hypertext markup language through a paragraph tag, div tag, heading tag, or canvas tag,
c. said image is outputted through a hypertext markup language image tag,
d. said audio file is outputted through a hypertext markup language audio tag,
e. said video file is outputted through a hypertext markup language video tag, and
f. said link is outputted through a hypertext markup language anchor tag,
and further including a message input page divided into sections wherein one section is for text, one section is for images, one section is for audio files, one section is for video files, and one section is for links, and a message output page divided into sections wherein one section is for text, one section is for images, one section is for audio files, one section is for video files, and one section is for links.

15. The machine of claim 14 further including:
a. a source attribute in said video tag or said audio tag,
b. a code snippet of hypertext markup language in a message web page template containing said video tag or said audio tag,
c. a variable placed in the location of the value of said source attribute of the tag in the code snippet,
d. a video file or audio file,
e. a file name and directory path of said video file or said audio file,
f. said computer performing interpolation of said file name and directory path of said video file or said audio file into said variable in the source attribute of said video tag or audio tag in the code snippet,
g. identifying data that associates a message part to a message by a means for joining a first data item to a second data item in a database, and
h. wherein said message part is a video file or audio file, said computer program processing said identifying data to identify a file name and directory path for said interpolation by a process of (1) receiving inputted data that corresponds to said
identifying data, (2) identifying the message corresponding to the identifying data, (3) identifying the file name and directory path associated with the message, and (4) interpolating the identified file name and directory path into the code snippet.

16. The machine of claim 14 further including that at least one or more elements selected from a group consisting of:
a. an output space for at least one or more messages, and
b. an input space to input a message
is outputted in a section of a content web page and wherein a message of a content web page is connected to a content web page by a means for associating a content web page's URL to a message.

17. The machine of claim 15 further including a title of said message and a plurality of metadata of said message, and further including a messaging system comprised of a first user, said first user having a first user's message input page, and a second user, said second user having an inbox and a second user's message output page, wherein said first user sends a sent message to said second user through the process of:
a. inputting a sent message into said first user's message input page,
b. said messaging system sending the sent message to the second user's inbox,
c. said second user's inbox displaying as a message's title and wherein the title is sorted using the metadata and further including an association between said title and said identifying data,
d. said second user inputting a selection of the sent message in the inbox,
e. said selection sending said identifying data to said messaging system, and
f. said sent message outputting in said second user's output message page.

18. The machine of claim 17 further including a message sent by a person within said messaging system to a person outside said messaging system having a third party email address wherein said messaging system sends an email to the third party email address wherein said email contains a link to a public message web page, and further including password protection for said public message web page and further including a password to unlock said password protection which is given to a recipient by a means for securely transferring a password from a sender to a recipient.

19. The machine of claim 17 further including a hashtag keyword, a message sent to said hashtag keyword by said first user, a selection of said hashtag keyword for said inbox by said second user, and a stream in said inbox comprised of a plurality of messages sent to said second user and messages sent to said hashtag.

20. The machine of claim 17 further including options selectable by said first user to review, edit, or cancel a message after it has been uploaded.
